(19) United States
(12) Patent Application Publication
(10) Pub. No.: US 2025/0068961 A1
(43) Pub. Date: Feb. 27, 2025

(54) SYSTEMS AND METHODS FOR DEPLOYING MACHINE LEARNING MODELS TRAINED ON SYNTHETIC DATA GENERATED BASED ON A PREDICTED FUTURE DATA DRIFT

(71) Applicant: Capital One Services, LLC, McLean, VA (US)

(72) Inventors: Michael DAVIS, Arlington, VA (US); Jeremy GOODSITT, Champaign, IL (US); Taylor TURNER, Richmond, VA (US); Kenny BEAN, Herndon, VA (US); Tyler FARNAN, San Diego, CA (US)

(73) Assignee: Capital One Services, LLC, McLean, VA (US)

(21) Appl. No.: 18/453,854

(22) Filed: Aug. 22, 2023

(51) Int. Cl. G06N 20/00

(52) U.S. Cl. CPC G06N 20/00

(57) ABSTRACT

Systems and methods for deploying machine learning models trained on synthetic data generated based on a predicted future data drift are described herein. In some aspects, the system analyzes data profiles that include snapshots of data from different points in time from the same data stream to predict a future data drift. The system generates synthetic data based on the previous data profiles. The system determines, based on a first and second data profile, that a first data drift exceeds a threshold and updates a machine learning model. The system determines a predicted data drift and generates a synthetic snapshot of the data stream corresponding to a time in the future. The system generates a speculative machine learning model from updating the first updated machine learning model based on the synthetic snapshot. The system deploys the speculative machine learning model to replace the first updated machine learning model.

### SUMMARY

The use of artificial intelligence has increased over recent years due to its ability to process data, find underlying patterns. and/or perform real-time determinations. However, despite these benefits, artificial intelligence and machine learning models have several technical problems. One major issue with machine learning models is dealing with data drift. Data drift refers to the issue when the properties of the data used to train a machine learning model change over time. Due to this issue, there is a decrease in the performance of the machine learning model. To avoid this problem, machine learning models can be retrained frequently to ensure the model stays accurate. However, this solution can be computationally expensive and time consuming. These technical problems may present an inherent problem with attempting to use an artificial intelligence-based solution where the training dataset is based on users' preferences because users' preferences are highly likely to change over time.

Methods and systems are described herein for novel uses and/or improvements to artificial intelligence applications. As one example, methods and systems are described herein for deploying a machine learning model trained on synthetic data generated based on a predicted future data drift.

Existing systems fail to predict data drifts before they happen. For example, existing systems attempt to anticipate data drifts and retrain the machine learning model frequently to avoid them from occurring. However, the difficulty in adapting artificial intelligence models for this practical benefit faces several technical challenges, such as the machine learning models being dependent on the quality and accuracy of the data; therefore, it is difficult to adapt artificial intelligence due to the lack of training data and the significant amount of computing power.

To overcome these technical deficiencies in adapting artificial intelligence models for this practical benefit, methods and systems disclosed herein analyze data profiles that include snapshots of data from different points in time from the same data stream to predict a future data drift. For example, by using data profiles, the system can track and detect data drifts. The system is able to generate synthetic data based on the previous data profiles received from the data stream. Using those data profiles and any detected data drifts, the system is able to generate a speculative machine learning model for any predicted data drifts based on the previous data drifts that occurred. Accordingly, the methods and systems provide for generating speculative machine learning models to accommodate for future data drifts.

In some aspects, the system may receive a first snapshot of a data stream captured at a first time and a second snapshot of the data stream captured at a second time. The system may process, using a data profiler function, the first snapshot of the data stream to generate a first data profile and the second snapshot of the data stream to generate a second data profile for the second snapshot. The system may determine, based on the first data profile and the second data profile, that a first data drift exceeds a threshold. The system may update a machine learning model based on the second snapshot to generate a first updated machine learning model. The system may determine a predicted data drift and generate a synthetic snapshot of the data stream corresponding to the third time in the future. The system generates a speculative machine learning model from updating the first updated machine learning model based on the synthetic snapshot. The system may process a third snapshot of the data stream to generate a third data profile for the third snapshot. The system may deploy the speculative machine learning model to replace the first updated machine learning model.

The system may receive a first snapshot of a data stream captured at a first time and a second snapshot of the data stream captured at a second time. In particular, the system receives a first snapshot of a data stream captured at a first time and a second snapshot of the data stream captured at a second time.

The system may process, using a data profiler function, the first snapshot of the data stream to generate a first data profile and the second snapshot of the data stream to generate a second data profile for the second snapshot. In particular, the system may process, using a data profiler function, the first snapshot of the data stream to generate a first data profile for the first snapshot. The system may process the second snapshot of the data stream to generate a second data profile for the second snapshot. By doing so, the system can compare the two data profiles to determine any changes in the data stream.

The system may determine, based on the first data profile and the second data profile, that a first data drift exceeds a threshold. In particular, the system may determine, based on the first data profile and the second data profile, that a first data drift between the first snapshot and the second snapshot exceeds a threshold. For example, the system may determine a data drift that happened due to customer behavior. For example, compared to the first data profile, the second data profile can indicate a higher number of customers likely to subscribe to a service. By doing so, the system is alerted to update the machine learning model.

The system may update a machine learning model based on the second snapshot to generate a first updated machine learning model. In particular, in response to determining that the first data drift exceeds the threshold, the system may update a machine learning model based on the second snapshot to generate a first updated machine learning model. The machine learning model was previously trained on the first snapshot. By doing so, the system may generate a first updated machine learning model to help address the data drift and ensures the machine learning model remains accurate over time.

The system may determine a predicted data drift and generate a synthetic snapshot of the data stream corresponding to the third time in the future. In particular, the system may extrapolate the first data drift to determine a predicted data drift corresponding to a third time in the future and generate, based on the predicted data drift, a synthetic snapshot of the data stream corresponding to the third time in the future. For example, the system may notice that customers have increased their engagement with action shows in the second snapshot. Therefore, when generating the synthetic snapshot, the system may modify a feature in the dataset to reflect the new user behavior. By doing so, the system is able to train a new machine learning model.

The system may generate a speculative machine learning model by updating the first updated machine learning model based on the synthetic snapshot. In particular, the system may generate a speculative machine learning model from updating the first updated machine learning model based on the synthetic snapshot. For example, the system may generate a new machine learning model based on the modified snapshot used to generate the synthetic snapshot. By doing so, the system can store the speculative machine learning model in case a second data drift does occur.

The system may process a third snapshot of the data stream to generate a third data profile for the third snapshot. In particular, the system may process, using the data profiler function, the third snapshot of the data stream to generate a third data profile for the third snapshot. The system may determine, based on the second data profile and the third data profile, that a second data drift between the second snapshot and the third snapshot exceeds the threshold. By doing so, the system is able to determine which machine learning model to deploy.

The system may deploy the speculative machine learning model to replace the first updated machine learning model. In particular, in response to determining that the second data drift exceeds the threshold, the system may deploy the speculative machine learning model to replace the first updated machine learning model. By doing so, the system is able to easily adapt to the data drift.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for generating speculative machine learning models for future data drifts, in accordance with one or more embodiments.

FIGS. 2A-2D show an illustrative diagram for determining a predicted data drift and generating a synthetic snapshot, in accordance with one or more embodiments.

FIG. 3 shows illustrative components for a system used to generate speculative machine learning models for future data drifts, in accordance with one or more embodiments.

FIG. 4 shows a flowchart of the steps involved in generating speculative machine learning models for future data drifts, in accordance with one or more embodiments.

### DETAILED DESCRIPTION

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

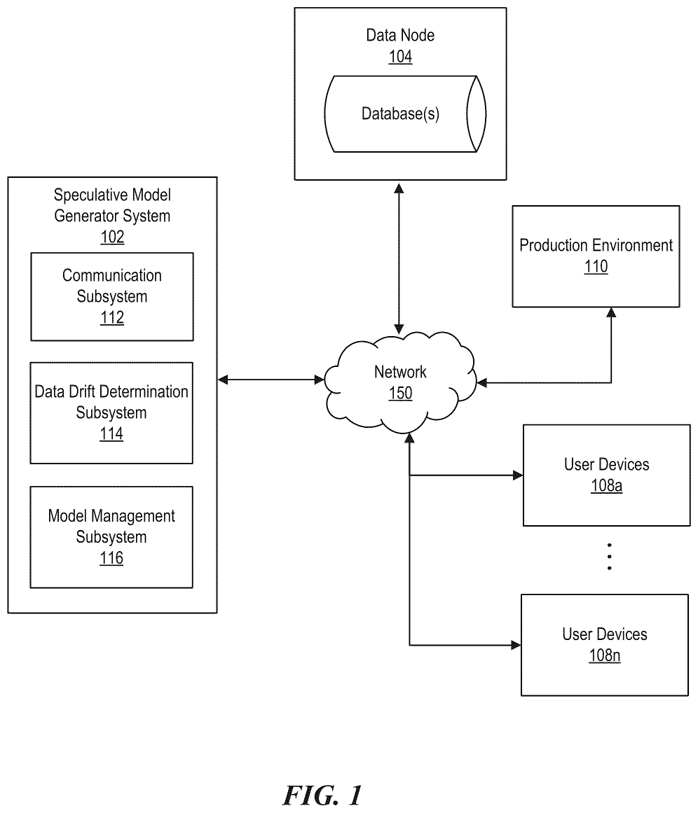

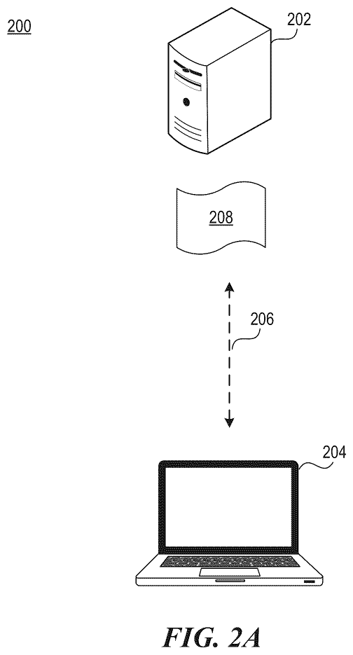

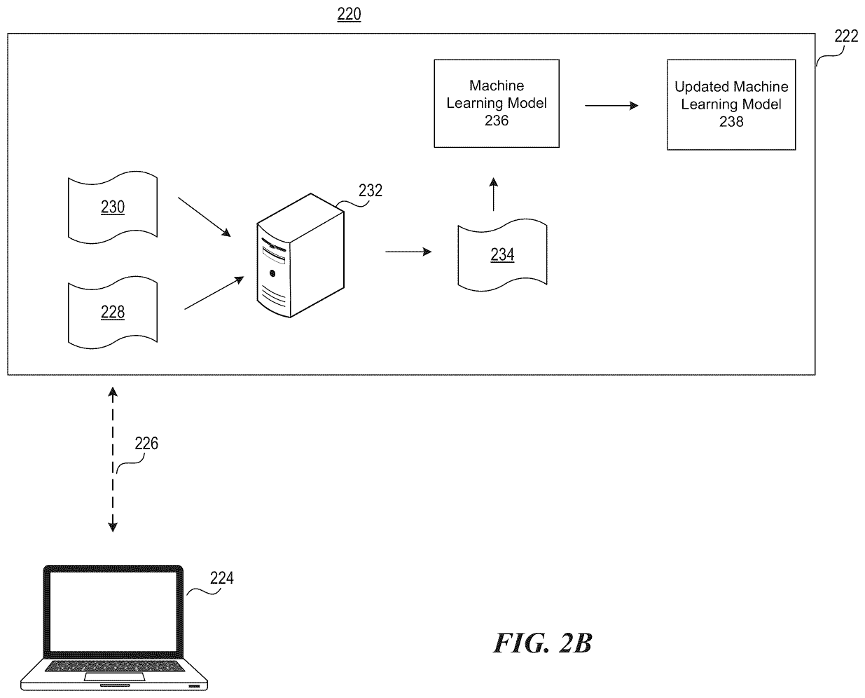

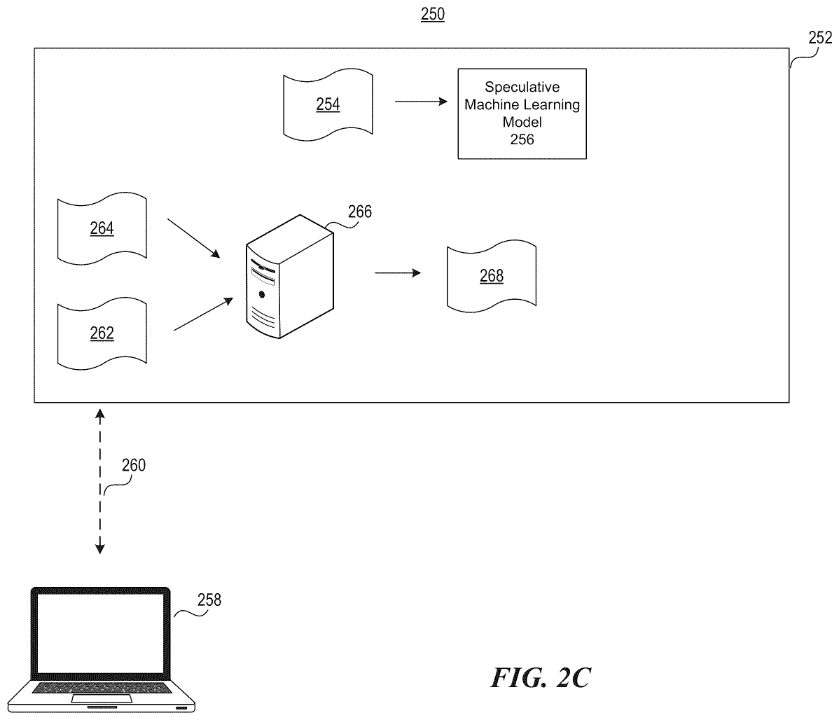

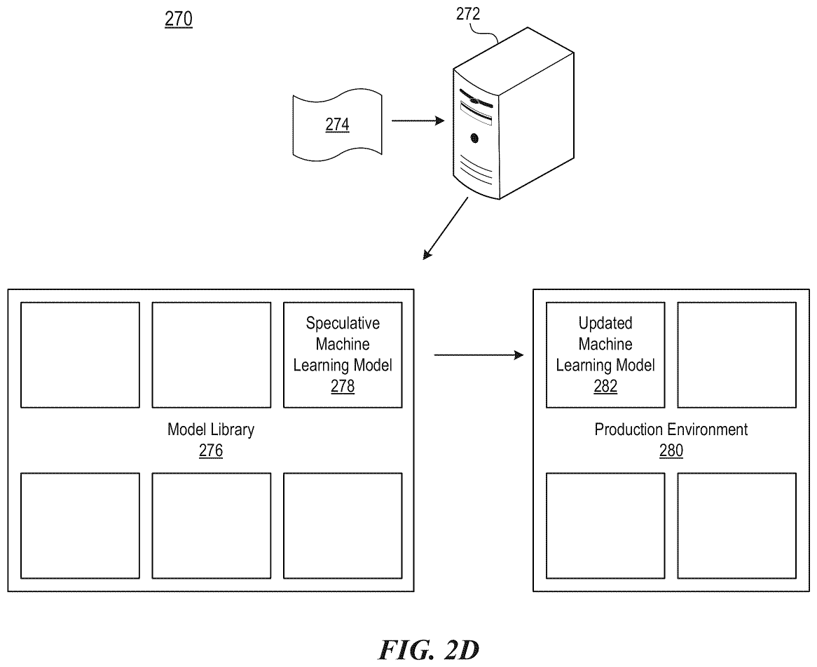

FIG. 1 shows an illustrative diagram for generating speculative machine learning models for future data drifts, in accordance with one or more embodiments. Environment 100 includes speculative model generator system 102, data node 104, user devices 108a-108n, and production environment 110. Speculative model generator system 102 may include software, hardware, or a combination of both and may reside on a physical server or a virtual server running on a physical computer system (e.g., server 202 described with respect to FIG. 2A). In some embodiments, speculative model generator system 102 may be configured on a user device (e.g., a laptop computer, a smartphone, a desktop computer, an electronic tablet, or another suitable user device). Furthermore, speculative model generator system 102 may reside on a cloud-based system and/or interface with computer models either directly or indirectly, for example, through network 150. Speculative model generator system 102 may include communication subsystem 112, data drift determination subsystem 114, and/or model management subsystem 116.

Data node 104 may store various data, including one or more machine learning models, training data, user data profiles, input data, output data, performance data, and/or other suitable data. Data node 104 may include software, hardware, or a combination of the two. In some embodiments, speculative model generator system 102 and data node 104 may reside on the same hardware and/or the same virtual server or computing device. Network 150 may be a local area network, a wide area network (e.g., the Internet), or a combination of the two.

Production environment 110 may include software, hardware, or a combination of the two. For example, the production environment may include software executed on hardware such as a physical device. In some embodiments, speculative model generator system 102 and production environment 110 may reside on the same hardware and/or the same virtual server or computing device.

Speculative model generator system 102 may receive user requests. Speculative model generator system 102 may receive data using communication subsystem 112, which may include software components, hardware components, or a combination of both. For example, communication subsystem 112 may include a network card (e.g., a wireless network card and/or a wired network card) that is associated with software to drive the card and enables communication with network 150. In some embodiments, communication subsystem 112 may also receive data from and/or communicate with data node 104 or another computing device. Communication subsystem 112 may receive data, such as training datasets. Communication subsystem 112 may communicate with data drift determination subsystem 114 and model management subsystem 116.

Speculative model generator system 102 may determine a data drift has occurred. Speculative model generator system 102 may determine a data drift has occurred using data drift determination subsystem 114. Communication subsystem 112 may pass at least a portion of the data or a pointer to the data in memory to data drift determination subsystem 114. Data drift determination subsystem 114 may include software components, hardware components, or a combination of both. For example, data drift determination subsystem 114 may include software components or may include one or more hardware components (e.g., processors) that are able to execute operations for training machine learning models. Data drift determination subsystem 114 may access data, such as training datasets. Data drift determination subsystem 114 may, additionally or alternatively, receive data from and/or send data to communication subsystem 112 and model management subsystem 116.

Speculative model generator system 102 may generate new machine learning models. Speculative model generator system 102 may generate new machine learning models using model management subsystem 116. Model management subsystem 116 may include software components, hardware components, or a combination of both. For example, model management subsystem 116 may include software components or may include one or more hardware components (e.g., processors) that are able to execute operations for processing user requests. Model management subsystem 116 may transmit data to production environment 110. Model management subsystem 116 may, additionally or alternatively, receive data from and/or send data to communication subsystem 112 and data drift determination subsystem 114.

FIG. 2A-FIG. 2D show illustrative diagrams for determining a predicted data drift and generating a synthetic snapshot, in accordance with one or more embodiments. FIG. 2A shows environment 200. Environment 200 includes server 202, user device 204, data stream 206, and snapshot 208.

Server 202 may receive a first snapshot (e.g., snapshot 208) of a data stream (e.g., data stream 206) captured at a first time. In particular, server 202 may receive a first snapshot of a data stream captured at a first time and a second snapshot of the data stream captured at a second time. For example, the system may receive a first snapshot 208 of data stream 206 captured at a first time and a second snapshot of data stream 206 captured at a later second time. By doing so, the system is able to determine whether any data drifts have occurred between the elapsed time from the first snapshot and second snapshot.

FIG. 2B shows environment 220. Environment 220 includes server 222, user device 224, data stream 226, snapshot 228, snapshot 230, data profiler 232, data profile 234, machine learning model 236, and updated machine learning model 238. In some embodiments, server 222 may be the same server as server 202. In some embodiments, data stream 226 may be the same as data stream 206.

Server 222 may process the first snapshot (e.g., snapshot 228) of the data stream (e.g., data stream 226) to generate a first data profile (e.g., data profile 234). In particular, server 222 may process, using a data profiler function (e.g., data profiler 232), the first snapshot (e.g., snapshot 228) of the data stream (e.g., data stream 226) to generate a first data profile for the first snapshot (e.g., data profile 234). The system may process the second snapshot (e.g., snapshot 230) of the data stream to generate a second data profile for the second snapshot. For example, the system may process snapshot 228 to generate data profile 234. Data profile 234 includes a statistical overview of data stream 226 at that time. For instance, data profile 234 may disclose, at that particular time, customers' preferences are centered around durable goods such as electronics. At a later time, the data profile may show that customers' preferences are centered around non-durable goods such as personal care items. By doing so, the system can compare the two data profiles to determine any changes in the data stream.

FIG. 2C shows environment 250. Environment 250 includes server 252, synthetic snapshot 254, speculative machine learning model 256, user device 258, data stream 260, data profile 262, data profile 264, processor 266, and data drift 268. In some embodiments, server 252 may be the same server as server 202 or server 222. In some embodiments, data stream 260 may be the same as data stream 206 or data stream 226.

Server 252 may determine, based on the first data profile (e.g., data profile 262) and the second data profile (e.g., data profile 264), that a first data drift (e.g., data drift 268) exceeds a threshold. In particular, server 252 may determine, based on the first data profile (e.g., data profile 262) and the second data profile (e.g., data profile 264), that a first data drift (e.g., data drift 268) between the first snapshot (e.g., snapshot 228) and the second snapshot (e.g., snapshot 230) exceeds a threshold. For example, the system may determine a data drift that happened due to customer behavior. For example, when determining, based on data profile 262 and data profile 264, whether data drift 268 between the first snapshot and the second snapshot exceeds a threshold, the system may detect a deviation in the distribution of the attributes between the first data profile and the second data profile. For example, the system may determine data profile 264 includes a disparate deviation in the distribution of attributes from data profile 262. In some embodiments, the threshold is determined based on size or frequency of a data profile. Server 252 may determine the first data drift (e.g., data drift 268) exceeds the threshold based on a similarity between the first data profile (e.g., data profile 262) and the second data profile (e.g., data profile 264). For example, the system may determine a similarity based on the distribution of the attributes in data profile 262 and data profile 264. By doing so, the system is alerted to update the machine learning model.

Server 222 may update a machine learning model (e.g., machine learning model 236) based on the second snapshot (e.g., snapshot 230) to generate a first updated machine learning model (e.g., updated machine learning model 238). In particular, in response to determining that the first data drift (e.g., data drift 268) exceeds the threshold, server 222 may update a machine learning model (e.g., machine learning model 236) based on the second snapshot (e.g., snapshot 230) to generate a first updated machine learning model (e.g., updated machine learning model 238). The machine learning model (e.g., machine learning model 236) was previously trained on the first snapshot (e.g., snapshot 228). For example, after determining there was a drift in customer preference, the system may update a machine learning model that generates recommendations for customers. By doing so, the system may generate a first updated machine learning model to help address the data drift and ensures the machine learning model remains accurate over time.

Server 252 may determine a predicted data drift (e.g., data drift 268) and generate a synthetic snapshot (e.g., synthetic snapshot 254) of the data stream (e.g., data stream 260) corresponding to the third time in the future. In particular, server 252 may extrapolate the first data drift to determine a predicted data drift (e.g., data drift 268) corresponding to a third time in the future and generate, based on the predicted data drift (e.g., data drift 268), a synthetic snapshot (e.g., synthetic snapshot 254) of the data stream (e.g., data stream 260) corresponding to the third time in the future. For example, the system may notice that customers have increased their engagement with non-durable goods in the second snapshot. Therefore, when generating synthetic snapshot 254, the system may modify a feature in the dataset to reflect the new user behavior. By doing so, the system is able to train a new machine learning model.

In some embodiments, server 252 may compare the first data profile and the second data profile to process the first data drift. In particular, server 252 may compare the first data profile to the second data profile to process the first data drift using a detection algorithm. The first data profile may include a first plurality of metrics. The first plurality of metrics may include statistics of the first data profile. The second data profile may include a second plurality of metrics. The second plurality of metrics may include statistics of the second data profile. Server 252 may determine the predicted data drift using a prediction machine learning model. The prediction machine learning model is trained using the similarity between the first plurality of metrics and the second plurality of metrics. The prediction machine learning model is validated using the similarity between the second plurality of metrics and a third plurality of metrics. The third plurality of metrics comprises statistics of the third data profile. For example, the system may use a prediction machine learning model to determine what the new customer preferences may be. By doing so, the system is able to determine a predicted data drift.

In some embodiments, server 252 may generate a synthetic snapshot (e.g., synthetic snapshot 254). In particular, server 252 may process the first data profile (e.g., data profile 262) and the second data profile (e.g., data profile 264) to determine an amount of random noise required. The amount of random noise maintains the privacy of a dataset while minimizing the amount of variation of the dataset. Server 252 may generate the random noise. The random noise comprises additional data. Server 252 may add the random noise to the dataset by modifying data in the dataset to the additional data. Server 252 may generate the synthetic snapshot (e.g., synthetic snapshot 254) based on the dataset.

In some embodiments, server 252 may identify a feature to replace in the second snapshot (e.g., snapshot 230) based on the predicted data drift (e.g., data drift 268). In particular, server 252 may identify a feature to replace in the second snapshot (e.g., snapshot 230) based on the predicted data drift (e.g., data drift 268). Server 252 may generate synthetic data to replace the feature in the second snapshot. The synthetic data has a distribution of values that are similar to the second snapshot and are able to generate the predicted data drift. Server 252 may replace the feature in the second snapshot with the synthetic data. By doing so, the system is able to generate a synthetic snapshot.

In some embodiments, server 252 may iteratively sample from the first snapshot (e.g., snapshot 228) and the second snapshot (e.g., snapshot 230). In particular, server 252 may iteratively sample from the first snapshot (e.g., snapshot 228) and the second snapshot (e.g., snapshot 230) to generate synthetic data for the predicted data drift (e.g., data drift 268). Server 252 may combine the synthetic data to generate a synthetic snapshot (e.g., synthetic snapshot 254). By doing so, the system is able to generate a synthetic snapshot for a future time.

Server 252 may generate a speculative machine learning model (e.g., speculative machine learning model 256) by updating the first updated machine learning model based on the synthetic snapshot (e.g., synthetic snapshot 254). In particular, server 252 may generate a speculative machine learning model (e.g., speculative machine learning model 256) from updating the first updated machine learning model based on the synthetic snapshot (e.g., synthetic snapshot 254). For example, the system may generate a speculative machine learning model 256 based on the modified snapshot used to generate the synthetic snapshot 254. For instance, based on the synthetic snapshot with predicted future customer preferences, the system is able to generate a new machine learning model. By doing so, the system can store the speculative machine learning model in case a second data drift does occur.

FIG. 2D shows environment 270. Environment 270 includes server 272, snapshot 274, model library 276, speculative machine learning model 278, production environment 280, and updated machine learning model 282. In some embodiments, server 252 may be the same server as server 202, server 222, or server 252.

Server 272 may process a third snapshot of the data stream to generate a third data profile (e.g., snapshot 274) for the third snapshot. In particular, server 272 may process, using the data profiler function, the third snapshot of the data stream to generate a third data profile (e.g., snapshot 274) for the third snapshot. The system may determine, based on the second data profile and the third data profile, that a second data drift between the second snapshot and the third snapshot exceeds the threshold. For example, the system may receive a new set of customer preferences from the data stream. By doing so, the system is able to determine which machine learning model to deploy.

Server 272 may deploy the speculative machine learning model (e.g., speculative machine learning model 278) to replace the first updated machine learning model (e.g., updated machine learning model 282). In particular, in response to determining that the second data drift exceeds the threshold, server 272 may deploy the speculative machine learning model (e.g., speculative machine learning model 278) to replace the first updated machine learning model (e.g., updated machine learning model 282). For example, the system may deploy speculative machine learning model 278 from model library 276 to production environment 280 to replace updated machine learning model 282. By doing so, the system is easily able to adapt to the data drift.

In some embodiments, server 272 may relabel the speculative machine learning model (e.g., speculative machine learning model 278) to be the second updated machine learning model. In particular, server 272 may determine whether a performance metric of the second updated machine learning model exceeds a performance metric of the speculative machine learning model (e.g., speculative machine learning model 278). In response to determining that the performance metric of the second updated machine learning model does not exceed the performance metric of the speculative machine learning model (e.g., speculative machine learning model 278), server 272 may relabel the speculative machine learning model to be the second updated machine learning model. In response to determining that the performance metric of the second updated machine learning model exceeds the performance metric of the speculative machine learning model, server 272 may deploy the second updated machine learning model to replace the speculative machine learning model (e.g., speculative machine learning model 278). For example, the system may determine whether speculative machine learning model 278 is more accurate than updated machine learning model 282. In response to determining it is, speculative machine learning model 278 is relabeled to second updated machine learning model.

In some embodiments, server 272 may remove the first data profile after a time period. The time period relates to the time needed to replace the first updated machine learning model. For example, after replacing updated machine learning model 282 with speculative machine learning model 278, the system is able to remove the first data profile from memory.

In some embodiments, server 272 may determine a performance threshold. In particular, the system may determine a performance threshold. The performance threshold is related to a performance metric of a machine learning model. In response to determining the machine learning model is not above the performance threshold, server 272 may update the machine learning model based on a new snapshot from the data stream. For example, the system may require all machine learning models to be at least 85 percent accurate. If the system determines a machine learning model is not meeting this threshold, the system may receive a new snapshot from the data stream to update the machine learning model. By doing so, the system is able to ensure the deployed machine learning model is accurate.

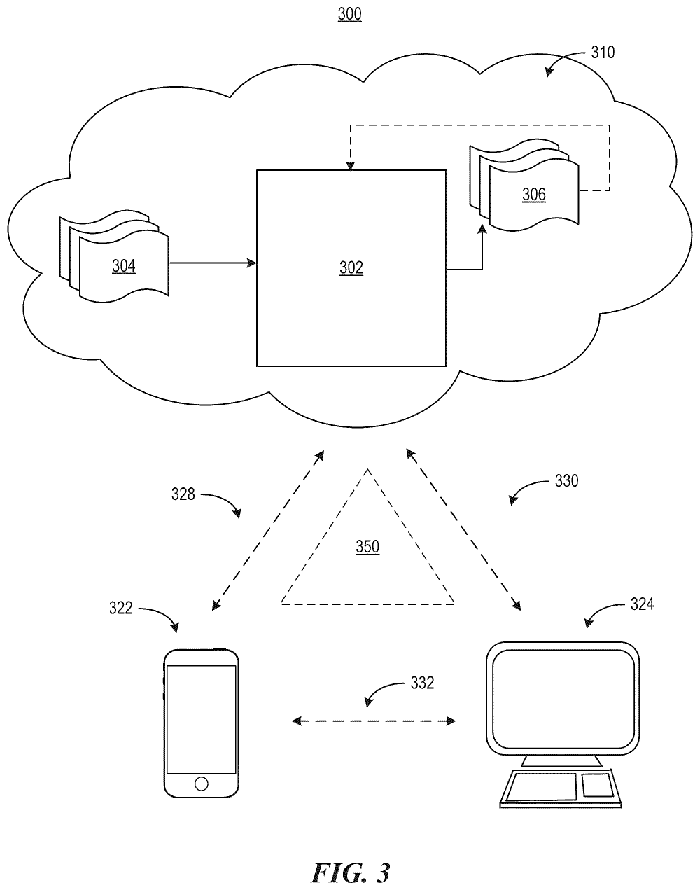

FIG. 3 shows illustrative components for a system used to generate speculative machine learning models for future data drifts, in accordance with one or more embodiments. For example, FIG. 3 may show illustrative components for generating synthetic data. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a handheld computer, and other computer equipment (e.g., a server), including “smart,” wireless, wearable, and/or mobile devices. FIG. 3 also includes cloud components 310. Cloud components 310 may alternatively be any computing device as described above and may include any type of mobile terminal, fixed terminal, or other device. For example, cloud components 310 may be implemented as a cloud computing system and may feature one or more component devices. It should also be noted that system 300 is not limited to three devices. Users may, for instance, utilize one or more devices to interact with one another, one or more servers, or other components of system 300. It should be noted that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or I/O circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational responses, queries, and/or notifications).

Additionally, as mobile device 322 and user terminal 324 are shown as a touchscreen smartphone and personal computer, these displays also act as user input interfaces. It should be noted that in some embodiments, the devices may have neither user input interfaces nor displays and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include speculative model generator system 102, communication subsystem 112, data drift determination subsystem 114, model management subsystem 116, production environment 110, data node 104, or client devices 108a-108n, and may be connected to network 150. Cloud components 310 may access machine learning models stored in production environment 110.

Cloud components 310 may include model 302, which may be a machine learning model, artificial intelligence model, etc. (which may be referred to collectively as “models” herein). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., predicting synthetic demographic information or customer preferences).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, backpropagation techniques may be utilized by model 302 where forward stimulation is used to reset weights on the “front” neural units. In some embodiments, stimulation and inhibition for model 302 may be more free flowing, with connections interacting in a more chaotic and complex fashion. During testing, an output layer of model 302 may indicate whether or not a given input corresponds to a classification of model 302 (e.g., classifying synthetic customers into labeled clusters).

In some embodiments, the model (e.g., model 302) may automatically perform actions based on outputs 306. In some embodiments, the model (e.g., model 302) may not perform any actions. The output of the model (e.g., model 302) may be used to generate synthetic snapshots of a data stream.

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be a REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350 such that there is a strong adoption of SOAP and RESTful Web services, using resources like Service Repository and Developer Portal, but with low governance, standardization, and separation of concerns. Alternatively, system 300 may be fully based on API layer 350 such that separation of concerns between layers like API layer 350, services, and applications are in place.

In some embodiments, the system architecture may use a microservice approach. Such systems may use two types of layers: front-end layer and back-end layer, where microservices reside. In this kind of architecture, the role of the API layer 350 may provide integration between the front end and back end. In such cases, ΛPI layer 350 may use RESTful AΛPIs (exposition to the front end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open source API platforms and their modules. API layer 350 may use a developer portal. API layer 350 may use strong security constraints applying WAF and DDoS protection, and API layer 350 may use RESTful APIs as a standard for external integration.

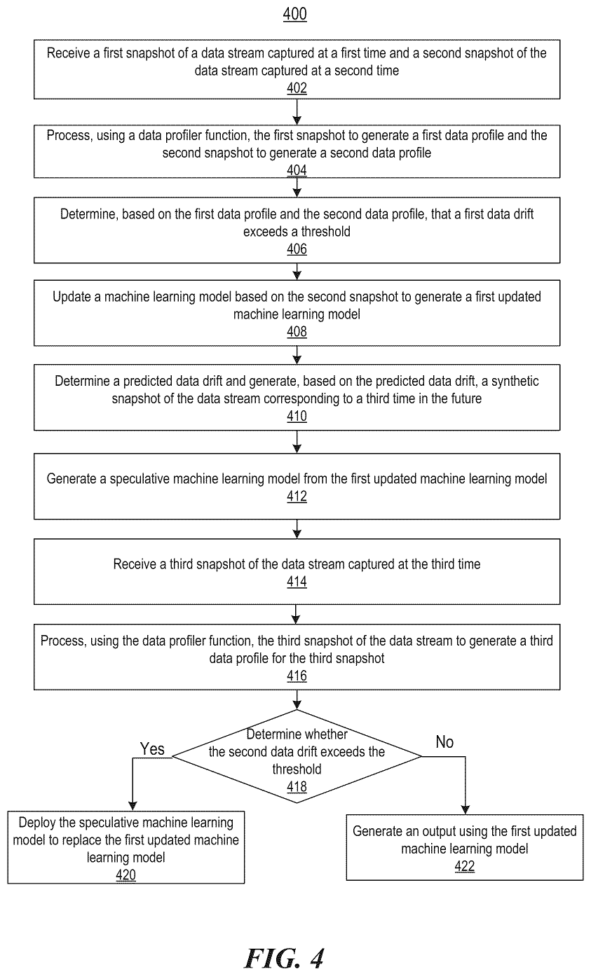

FIG. 4 shows a flowchart of the steps involved in generating speculative machine learning models for future data drifts, in accordance with one or more embodiments. For example, the system may use process 400 (e.g., as implemented on one or more system components described above) in order to generate synthetic data.

At operation 402, process 400 (e.g., using one or more components described above) may receive a first snapshot of a data stream captured at a first time and a second snapshot of the data stream captured at a second time. For example, the system may receive a first snapshot of a data stream captured at a first time and a second snapshot of the data stream captured at a second time. For example, communication subsystem 112 may receive a first snapshot (e.g., snapshot 208 or snapshot 228) of a data stream (e.g., data stream 206 or data stream 226) captured at a first time and a second snapshot (e.g., snapshot 230) of the data stream (e.g., data stream 206 or data stream 226) captured at a second time.

At operation 404, process 400 (e.g., using one or more components described above) may process, using a data profiler function, the first snapshot to generate a first data profile and the second snapshot to generate a second data profile. For example, the system may process, using a data profiler function, the first snapshot of the data stream to generate a first data profile for the first snapshot. The system may process the second snapshot of the data stream to generate a second data profile for the second snapshot. For example, data drift determination subsystem 114 may process, using a data profiler function (e.g., data profiler 232), the first snapshot (e.g., snapshot 208 or snapshot 228) of the data stream (e.g., data stream 206 or data stream 226) to generate a first data profile (e.g., data profile 234 or data profile 262) for the first snapshot (e.g., snapshot 208 or snapshot 228). Data drift determination subsystem 114 may process the second snapshot (e.g., snapshot 230) of the data stream (e.g., data stream 206, data stream 226, or data stream 260) to generate a second data profile for the second snapshot (e.g., snapshot 230). By doing so, the system can compare the two data profiles to determine any changes in the data stream.

At operation 406, process 400 (e.g., using one or more components described above) may determine, based on the first data profile and the second data profile, that a first data drift exceeds a threshold. For example, the system may determine, based on the first data profile and the second data profile, that a first data drift between the first snapshot and the second snapshot exceeds a threshold. For example, data drift determination subsystem 114 may determine, based on the first data profile (e.g., data profile 234 or data profile 262) and the second data profile (e.g., data profile 264), that a first data drift (e.g., data drift 268) between the first snapshot (e.g., snapshot 208 or snapshot 228) and the second snapshot (e.g., snapshot 230) exceeds a threshold. For example, when determining, based on the first data profile (e.g., data profile 234 or data profile 262) and the second data profile (e.g., data profile 264), that a first data drift (e.g., data drift 268) between the first snapshot (e.g., snapshot 208 or snapshot 228) and the second snapshot (e.g., snapshot 230) exceeds a threshold, the system may detect a deviation in the distribution of the attributes between the first data profile (e.g., data profile 234 or data profile 262) and the second data profile (e.g., data profile 264). By doing so, the system is alerted to update the machine learning model.

At operation 408, process 400 (e.g., using one or more components described above) may update a machine learning model based on the second snapshot to generate a first updated machine learning model. For example, in response to determining that the first data drift exceeds the threshold, the system may update a machine learning model based on the second snapshot to generate a first updated machine learning model. The machine learning model was previously trained on the first snapshot. For example, in response to determining that the first data drift (e.g., data drift 268) exceeds the threshold, model management subsystem 116 may update a machine learning model (e.g., machine learning model 236) based on the second snapshot (e.g., snapshot 230) to generate a first updated machine learning model (e.g., updated machine learning model 238). The machine learning model (e.g., machine learning model 236) was previously trained on the first snapshot (e.g., snapshot 208 or snapshot 228). By doing so, the system may generate a first updated machine learning model to help address the data drift and ensures the machine learning model remains accurate over time.

In some embodiments, the threshold is determined based on size or frequency of a data profile and when determining the first data drift exceeds the threshold is based on a similarity between the first data profile and the second data profile. For example, the threshold is determined based on size or frequency of a data profile and wherein determining the first data drift (e.g., data drift 268) exceeds the threshold is based on a similarity between the first data profile (e.g., data profile 234 or data profile 262) and the second data profile (e.g., data profile 264).

At operation 410, process 400 (e.g., using one or more components described above) may determine a predicted data drift and generate, based on the predicted data drift, a synthetic snapshot of the data stream corresponding to the third time in the future. For example, the system may extrapolate the first data drift to determine a predicted data drift corresponding to a third time in the future and generate, based on the predicted data drift, a synthetic snapshot of the data stream corresponding to the third time in the future. For example, data drift determination subsystem 114 may extrapolate the first data drift (e.g., data drift 268) to determine a predicted data drift corresponding to a third time in the future and generate, based on the predicted data drift, a synthetic snapshot (e.g., synthetic snapshot 254) of the data stream corresponding to the third time in the future. By doing so, the system is able to train a new machine learning model.

In some embodiments, the system may compare the first data profile and the second data profile to process the first data drift. For example, data drift determination subsystem 114 may compare the first data profile (e.g., data profile 234 or data profile 262) to the second data profile (e.g., data profile 264) to process the first data drift (e.g., data drift 268) using a detection algorithm. The first data profile (e.g., data drift 268) may include a first plurality of metrics. The first plurality of metrics may include statistics of the first data profile (e.g., data profile 234 or data profile 262). The second data profile (e.g., data profile 264) may include a second plurality of metrics. The second plurality of metrics may include statistics of the second data profile (e.g., data profile 264). The system may determine the predicted data drift using a prediction machine learning model. The prediction machine learning model is trained using the similarity between the first plurality of metrics and the second plurality of metrics. The prediction machine learning model is validated using the similarity between the second plurality of metrics and a third plurality of metrics. The third plurality of metrics comprises statistics of the third data profile.

In some embodiments, the system may generate a synthetic snapshot. For example, data drift determination subsystem 114 may process the first data profile (e.g., data profile 234 or data profile 262) and the second data profile (e.g., data profile 264) to determine an amount of random noise required. The amount of random noise maintains the privacy of a dataset while minimizing the amount of variation of the dataset. Data drift determination subsystem 114 may generate the random noise. The random noise comprises additional data. Data drift determination subsystem 114 may add the random noise to the dataset by modifying data in the dataset to the additional data. Data drift determination subsystem 114 may generate the synthetic snapshot (e.g., synthetic snapshot 254) based on the dataset.

In some embodiments, the system may identify a feature to replace in the second snapshot based on the predicted data drift. For example, the system may identify a feature to replace in the second snapshot (e.g., snapshot 230) based on the predicted data drift. The system may generate synthetic data to replace the feature in the second snapshot (e.g., snapshot 230). The synthetic data has a distribution of values that are similar to the second snapshot (e.g., snapshot 230) and are able to generate the predicted data drift. The system may replace the feature in the second snapshot (e.g., snapshot 230) with the synthetic data.

In some embodiments, the system may iteratively sample from the first snapshot (e.g., snapshot 208 or snapshot 228) and the second snapshot (e.g., snapshot 230). For example, data drift determination subsystem 114 may iteratively sample from the first snapshot (e.g., snapshot 208 or snapshot 228) and the second snapshot (e.g., snapshot 230) to generate synthetic data for the predicted data drift. Data drift determination subsystem 114 may combine the synthetic data to generate a synthetic snapshot (e.g., synthetic snapshot 254).

At operation 412, process 400 (e.g., using one or more components described above) may generate a speculative machine learning model from the first updated machine learning model. For example, model management subsystem 116 may generate a speculative machine learning model (e.g., speculative machine learning model 256 or speculative machine learning model 278 or model 302) from updating the first updated machine learning model (e.g., updated machine learning model 238) based on the synthetic snapshot (e.g., synthetic snapshot 254). For example, model management subsystem 116 may generate a new machine learning model (e.g., speculative machine learning model 256 or speculative machine learning model 278 or model 302) based on the modified snapshot used to generate the synthetic snapshot (e.g., synthetic snapshot 254). By doing so, the system can store the speculative machine learning model in case a second data drift does occur.

At operation 414, process 400 (e.g., using one or more components described above) may receive a third snapshot of the data stream captured at a third time. For example, communication subsystem 112 may receive a third snapshot (e.g., snapshot 274) of the data stream captured at the third time.

At operation 416, process 400 (e.g., using one or more components described above) may process, using the data profiler function, the third snapshot of the data stream to generate a third data profile for the third snapshot. For example, data drift determination subsystem 114 may process, using the data profiler function (e.g., data profiler 232), the third snapshot (e.g., snapshot 274) of the data stream to generate a third data profile for the third snapshot (e.g., snapshot 274). Data drift determination subsystem 114 may determine, based on the second data profile (e.g., data profile 264) and the third data profile, that a second data drift between the second snapshot and the third snapshot exceeds the threshold. By doing so, the system is able to determine which machine learning model to deploy.

At operation 418, process 400 (e.g., using one or more components described above) may determine whether the second data drift exceeds the threshold. For example, data drift determination subsystem 114 may determine whether the second data drift exceeds the threshold.

At operation 420, process 400 (e.g., using one or more components described above) may deploy the speculative machine learning model to replace the first updated machine learning model. For example, in response to determining that the second data drift exceeds the threshold, model management subsystem 116 may deploy the speculative machine learning model (e.g., speculative machine learning model 278) to replace the first updated machine learning model (e.g., updated machine learning model 282). By doing so, the system is able to easily adapt to the data drift.

At operation 422, process 400 (e.g., using one or more components described above) may generate an output using the first updated machine learning model. For example, in response to determining that the second data drift does not exceed the threshold, model management subsystem 116 may generate an output (e.g., output 306) using the first updated machine learning model (e.g., updated machine learning model 282).

In some embodiments, the system may relabel the speculative machine learning model to be the second updated machine learning model. For example, model management subsystem 116 may determine whether a performance metric of the second updated machine learning model exceeds a performance metric of the speculative machine learning model (e.g., speculative machine learning model 278). In response to determining that the performance metric of the second updated machine learning model does not exceed the performance metric of the speculative machine learning model (e.g., speculative machine learning model 278), the system may relabel the speculative machine learning model (e.g., speculative machine learning model 278) to be the second updated machine learning model. In response to determining that the performance metric of the second updated machine learning model exceeds the performance metric of the speculative machine learning model (e.g., speculative machine learning model 278), the system may deploy the second updated machine learning model to replace the speculative machine learning model.

In some embodiments, the system may remove the first data profile after a time period. For example, data drift determination subsystem 114 may remove the first data profile (e.g., data drift 268) after a time period wherein the time period relates to the time needed to replace the first updated machine learning model.

In some embodiments, the system may determine a performance threshold. For example, data drift determination subsystem 114 may determine a performance threshold, wherein the performance threshold is related to a performance metric of a machine learning model (e.g., machine learning model 236, updated machine learning model 282, or model 302). In response to determining the machine learning model is not above the performance threshold, the system updates the machine learning model based on a new snapshot from the data stream.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims that follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method, comprising: receiving a first snapshot of a data stream captured at a first time and a second snapshot of the data stream captured at a second time; processing, using a data profiler function, the first snapshot of the data stream, to generate a first data profile for the first snapshot, and the second snapshot of the data stream, to generate a second data profile for the second snapshot; determining, based on the first data profile and the second data profile, that a first data drift between the first snapshot and the second snapshot exceeds a threshold; in response to determining that the first data drift exceeds the threshold, updating a machine learning model based on the second snapshot to generate a first updated machine learning model, wherein the machine learning model was previously trained on the first snapshot; extrapolating the first data drift to determine a predicted data drift corresponding to a third time in the future and generating, based on the predicted data drift, a synthetic snapshot of the data stream corresponding to the third time in the future; generating a speculative machine learning model from updating the first updated machine learning model based on the synthetic snapshot; receiving a third snapshot of the data stream captured at the third time; processing, using the data profiler function, the third snapshot of the data stream to generate a third data profile for the third snapshot; determining, based on the second data profile and the third data profile, that a second data drift between the second snapshot and the third snapshot exceeds the threshold; and in response to determining that the second data drift exceeds the threshold, deploying the speculative machine learning model to replace the first updated machine learning model.
2. A method, comprising determining, based on a first data profile for a first snapshot of a data stream captured at a first time and a second data profile for a second snapshot of the data stream captured at a second time, that a first data drift between the first snapshot and the second snapshot exceeds a threshold; in response to determining that the first data drift exceeds the threshold, updating a machine learning model based on the second snapshot to generate a first updated machine learning model, wherein the machine learning model was previously trained on the first snapshot; extrapolating the first data drift to determine a predicted data drift corresponding to a third time in the future and generating, based on the predicted data drift, a synthetic snapshot of the data stream corresponding to the third time in the future; generating a speculative machine learning model from updating the first updated machine learning model based on the synthetic snapshot; determining, based on the second data profile and a third data profile for a third snapshot of the data stream captured at the third time, that a second data drift between the second snapshot and the third snapshot exceeds the threshold; and in response to determining that the second data drift exceeds the threshold, deploying the speculative machine learning model to replace the first updated machine learning model.
3. A method, comprising: determining, based on a first data profile for a first snapshot of a data stream captured at a first time and a second data profile for a second snapshot of the data stream captured at a second time, that a first data drift between the first snapshot and the second snapshot exceeds a threshold; in response to determining that the first data drift exceeds the threshold, extrapolating the first data drift to determine a predicted data drift corresponding to a third time in the future and generating, based on the predicted data drift, a synthetic snapshot of the data stream corresponding to the third time in the future; generating a speculative machine learning model based on the synthetic snapshot; determining, based on the second data profile and a third data profile for a third snapshot of the data stream captured at the third time, that a second data drift between the second snapshot and the third snapshot exceeds the threshold; and in response to determining that the second data drift exceeds the threshold, deploying the speculative machine learning model.
4. The method of any one of the preceding embodiments, further comprising: in response to determining that the second data drift exceeds the threshold, updating the first updated machine learning model based on the third snapshot to generate a second updated machine learning model; and subsequent to the second updated machine learning model being generated: determining whether a performance metric of the second updated machine learning model exceeds a performance metric of the speculative machine learning model; and in response to determining that the performance metric of the second updated machine learning model does not exceed the performance metric of the speculative machine learning model, relabeling the speculative machine learning model to be the second updated machine learning model; and in response to determining that the performance metric of the second updated machine learning model exceeds the performance metric of the speculative machine learning model, deploying the second updated machine learning model to replace the speculative machine learning model.
5. The method of any one of the preceding embodiments, further comprising removing the first data profile after a time period, wherein the time period relates to the time needed to replace the first updated machine learning model.
6. The method of any one of the preceding embodiments, wherein extrapolating the first data drift to determine a predicted data drift further comprises: comparing the first data profile to the second data profile to process the first data drift using a detection algorithm, wherein the first data profile comprises a first plurality of metrics, wherein the first plurality of metrics comprises statistics of the first data profile, wherein the second data profile comprises a second plurality of metrics, and wherein the second plurality of metrics comprises statistics of the second data profile; and determining the predicted data drift using a prediction machine learning model, wherein the prediction machine learning model is trained using the similarity between the first plurality of metrics and the second plurality of metrics, and wherein the prediction machine learning model is validated using the similarity between the second plurality of metrics and a third plurality of metrics, wherein the third plurality of metrics comprises statistics of the third data profile.
7. The method of any one of the preceding embodiments, wherein the threshold is determined based on size or frequency of a data profile, and wherein determining the first data drift exceeds the threshold is based on the similarity between the first data profile and the second data profile.
8. The method of any one of the preceding embodiments, further comprising: determining a performance threshold, wherein the performance threshold is related to a performance metric of a machine learning model; and in response to determining the machine learning model is not above the performance threshold, updating the machine learning model based on a new snapshot from the data stream.
9. The method of any one of the preceding embodiments, wherein determining, based on the first data profile and the second data profile, that a first data drift between the first snapshot and the second snapshot exceeds a threshold further comprises detecting a deviation in the distribution of the attributes between the first data profile and the second data profile.
10. The method of any one of the preceding embodiments, wherein generating, based on the predicted data drift, a synthetic snapshot of the data stream corresponding to the third time in the future further comprises: identifying a feature to replace in the second snapshot based on the predicted data drift; generating synthetic data to replace the feature in the second snapshot, wherein the synthetic data has a distribution of values that are similar to the second snapshot and are able to generate the predicted data drift; and replacing the feature in the second snapshot with the synthetic data.
11. The method of any one of the preceding embodiments, further comprising: iteratively sampling from the first snapshot and the second snapshot to generate synthetic data for the predicted data drift; and combining the synthetic data to generate a synthetic snapshot.
12. The method of any one of the preceding embodiments, wherein generating, based on the predicted data drift, a synthetic snapshot of the data stream corresponding to the third time in the future further comprises: processing the first data profile and the second data profile to determine an amount of random noise required, wherein the amount of random noise maintains the privacy of a dataset while minimizing the amount of variation of the dataset; generating the random noise, wherein the random noise comprises additional data; adding the random noise to the dataset by modifying data in the dataset to the additional data; and generating the synthetic snapshot based on the dataset.
13. A tangible, non-transitory, machine-readable medium storing instructions that, when executed by a data processing apparatus, cause the data processing apparatus to perform operations comprising those of any of embodiments 1-12.
14. A system comprising one or more processors; and memory-storing instructions that, when executed by the processors, cause the processors to effectuate operations comprising those of any of embodiments 1-12.
15. A system comprising means for performing any of embodiments 1-12.

What is claimed is:

1. A system for deploying a machine learning model trained on synthetic data generated based on a predicted future data drift, comprising:
one or more processors; and
one or more non-transitory, computer-readable media storing instructions that, when executed by the one or more processors, cause operations comprising:
receiving a first snapshot of a data stream captured at a first time and a second snapshot of the data stream captured at a second time;
processing, using a data profiler function, the first snapshot of the data stream, to generate a first data profile for the first snapshot, and the second snapshot of the data stream, to generate a second data profile for the second snapshot;
determining, based on the first data profile and the second data profile, that a first data drift between the first snapshot and the second snapshot exceeds a threshold;
in response to determining that the first data drift exceeds the threshold, updating a machine learning model based on the second snapshot to generate a first updated machine learning model, wherein the machine learning model was previously trained on the first snapshot;
extrapolating the first data drift to determine a predicted data drift corresponding to a third time in the future and generating, based on the predicted data drift, a synthetic snapshot of the data stream corresponding to the third time in the future;
generating a speculative machine learning model from updating the first updated machine learning model based on the synthetic snapshot;
receiving a third snapshot of the data stream captured at the third time;
processing, using the data profiler function, the third snapshot of the data stream to generate a third data profile for the third snapshot;
determining, based on the second data profile and the third data profile, that a second data drift between the second snapshot and the third snapshot exceeds the threshold; and
in response to determining that the second data drift exceeds the threshold, deploying the speculative machine learning model to replace the first updated machine learning model.

2. The system of claim 1, the operations further comprising:
in response to determining that the second data drift exceeds the threshold, updating the first updated machine learning model based on the third snapshot to generate a second updated machine learning model; and
subsequent to the second updated machine learning model being generated:
determining whether a performance metric of the second updated machine learning model exceeds a performance metric of the speculative machine learning model;
in response to determining that the performance metric of the second updated machine learning model does not exceed the performance metric of the speculative machine learning model, relabeling the speculative machine learning model to be the second updated machine learning model; and
in response to determining that the performance metric of the second updated machine learning model exceeds the performance metric of the speculative machine learning model, deploying the second updated machine learning model to replace the speculative machine learning model.

3. A method of deploying a machine learning model trained on synthetic data generated based on a predicted future data drift, comprising:
determining, based on a first data profile for a first snapshot of a data stream captured at a first time and a second data profile for a second snapshot of the data stream captured at a second time, that a first data drift between the first snapshot and the second snapshot exceeds a threshold;
in response to determining that the first data drift exceeds the threshold, updating a machine learning model based on the second snapshot to generate a first updated machine learning model, wherein the machine learning model was previously trained on the first snapshot;
extrapolating the first data drift to determine a predicted data drift corresponding to a third time in the future and generating, based on the predicted data drift, a synthetic snapshot of the data stream corresponding to the third time in the future;
generating a speculative machine learning model from updating the first updated machine learning model based on the synthetic snapshot;
determining, based on the second data profile and a third data profile for a third snapshot of the data stream captured at the third time, that a second data drift between the second snapshot and the third snapshot exceeds the threshold; and
in response to determining that the second data drift exceeds the threshold, deploying the speculative machine learning model to replace the first updated machine learning model.

4. The method of claim 3, further comprising:
in response to determining that the second data drift exceeds the threshold, updating the first updated machine learning model based on the third snapshot to generate a second updated machine learning model; and
subsequent to the second updated machine learning model being generated:
determining whether a performance metric of the second updated machine learning model exceeds a performance metric of the speculative machine learning model; and
in response to determining that the performance metric of the second updated machine learning model does not exceed the performance metric of the speculative machine learning model, relabeling the speculative machine learning model to be the second updated machine learning model; and
in response to determining that the performance metric of the second updated machine learning model exceeds the performance metric of the speculative machine learning model, deploying the second updated machine learning model to replace the speculative machine learning model.

5. The method of claim 3, further comprises removing the first data profile after a time period, wherein the time period relates to the time needed to replace the first updated machine learning model.

6. The method of claim 3, wherein extrapolating the first data drift to determine a predicted data drift further comprises:
comparing the first data profile to the second data profile to process the first data drift using a detection algorithm, wherein the first data profile comprises a first plurality of metrics, wherein the first plurality of metrics comprises statistics of the first data profile, wherein the second data profile comprises a second plurality of metrics, and wherein the second plurality of metrics comprises statistics of the second data profile; and
determining the predicted data drift using a prediction machine learning model, wherein the prediction machine learning model is trained using a similarity between the first plurality of metrics and the second plurality of metrics, and wherein the prediction machine learning model is validated using the similarity between the second plurality of metrics and a third plurality of metrics, wherein the third plurality of metrics comprises statistics of the third data profile.

7. The method of claim 3, wherein the threshold is determined based on size or frequency of a data profile, and wherein determining the first data drift exceeds the threshold is based on a similarity between the first data profile and the second data profile.

8. The method of claim 3, further comprising:
determining a performance threshold, wherein the performance threshold is related to a performance metric of a machine learning model; and
in response to determining the machine learning model is not above the performance threshold, updating the machine learning model based on a new snapshot from the data stream.

9. The method of claim 3, wherein determining, based on the first data profile and the second data profile, that a first data drift between the first snapshot and the second snapshot exceeds a threshold further comprises detecting a deviation in a distribution of attributes between the first data profile and the second data profile.

10. The method of claim 3, wherein generating, based on the predicted data drift, a synthetic snapshot of the data stream corresponding to the third time in the future further comprises:
identifying a feature to replace in the second snapshot based on the predicted data drift;
generating synthetic data to replace the feature in the second snapshot, wherein the synthetic data has a distribution of values that are similar to the second snapshot and are able to generate the predicted data drift; and
replacing the feature in the second snapshot with the synthetic data.

11. The method of claim 10, further comprising:
iteratively sampling from the first snapshot and the second snapshot to generate synthetic data for the predicted data drift; and
combining the synthetic data to generate a synthetic snapshot.

12. The method of claim 3, wherein generating, based on the predicted data drift, a synthetic snapshot of the data stream corresponding to the third time in the future further comprises:
processing the first data profile and the second data profile to determine an amount of random noise required, wherein the amount of random noise maintains the privacy of a dataset while minimizing the amount of variation of the dataset;
generating the random noise, wherein the random noise comprises additional data;
adding the random noise to the dataset by modifying data in the dataset to the additional data; and
generating the synthetic snapshot based on the dataset.

13. One or more non-transitory, computer-readable storage media storing instructions that, when executed by one or more processors, cause operations comprising:
determining, based on a first data profile for a first snapshot of a data stream captured at a first time and a second data profile for a second snapshot of the data stream captured at a second time, that a first data drift between the first snapshot and the second snapshot exceeds a threshold;
in response to determining that the first data drift exceeds the threshold, extrapolating the first data drift to determine a predicted data drift corresponding to a third time in the future and generating, based on the predicted data drift, a synthetic snapshot of the data stream corresponding to the third time in the future;
generating a speculative machine learning model based on the synthetic snapshot;
determining, based on the second data profile and a third data profile for a third snapshot of the data stream captured at the third time, that a second data drift between the second snapshot and the third snapshot exceeds the threshold; and
in response to determining that the second data drift exceeds the threshold, deploying the speculative machine learning model.

14. The one or more non-transitory, computer-readable storage media of claim 13, wherein the instructions further cause the one or more processors to perform operations comprising:
in response to determining that the first data drift exceeds the threshold, updating a machine learning model based on the second snapshot to generate a first updated machine learning model. wherein the machine learning model was previously trained on the first snapshot.

15. One or more non-transitory, computer-readable storage media of claim 14, wherein the instructions further cause the one or more processors to perform operations comprising:
in response to determining that the second data drift exceeds the threshold, updating the first updated machine learning model based on the third snapshot to generate a second updated machine learning model; and
subsequent to the second updated machine learning model being generated:
determining whether a performance metric of the second updated machine learning model exceeds a performance metric of the speculative machine learning model; and
in response to determining that the performance metric of the second updated machine learning model does not exceed the performance metric of the speculative machine learning model, relabeling the speculative machine learning model to be the second updated machine learning model; and
in response to determining that the performance metric of the second updated machine learning model exceeds the performance metric of the speculative machine learning model, deploying the second updated machine learning model to replace the speculative machine learning model.

16. One or more non-transitory, computer-readable storage media of claim 13, wherein extrapolating the first data drift to determine a predicted data drift further cause the one or more processors to perform operations comprising:
comparing the first data profile to the second data profile to process the first data drift using a detection algorithm, wherein the first data profile comprises a first plurality of metrics, wherein the first plurality of metrics comprises statistics of the first data profile, wherein the second data profile comprises a second plurality of metrics, and wherein the second plurality of metrics comprises statistics of the second data profile; and
determining the predicted data drift using a prediction machine learning model, wherein the prediction machine learning model is trained using a similarity between the first plurality of metrics and the second plurality of metrics, and wherein the prediction machine learning model is validated using the similarity between the second plurality of metrics and a third plurality of metrics, wherein the third plurality of metrics comprises statistics of the third data profile.

17. One or more non-transitory, computer-readable storage media of claim 13, wherein the instructions further cause the one or more processors to perform operations comprising:
determining a performance threshold, wherein the performance threshold is related to a performance metric of a machine learning model; and
in response to determining the machine learning model is not above the performance threshold, updating the machine learning model based on a new snapshot from the data stream.

18. One or more non-transitory, computer-readable storage media of claim 13, wherein generating, based on the predicted data drift, a synthetic snapshot of the data stream corresponding to the third time in the future further comprises:
identifying a feature to replace in the second snapshot based on the predicted data drift;
generating synthetic data to replace the feature in the second snapshot, wherein the synthetic data has a distribution of values that are similar to the second snapshot and are able to generate the predicted data drift; and
replacing the feature in the second snapshot with the synthetic data.

19. One or more non-transitory, computer-readable storage media of claim 18, wherein the instructions further cause the one or more processors to perform operations comprising:
iteratively sampling from the first snapshot and the second snapshot to generate synthetic data for the predicted data drift; and
combining the synthetic data to generate a synthetic snapshot.

20. One or more non-transitory, computer-readable storage media of claim 13, wherein the threshold is determined based on size or frequency of a data profile, and wherein determining the first data drift exceeds the threshold is based on a similarity between the first data profile and the second data profile.
